(19) United States
(12) Patent Application Publication
(10) Pub. No.: US 2006/0062190 A1
(43) Pub. Date: Mar. 23, 2006

(54) Wireless network system, communication method, communication apparatus, wireless terminal, communication control program, and terminal control program

(75) Inventor: Junichi Suga, Kawasaki (JP)

Correspondence Address: SWIDLER BERLIN LLP, 3000 K STREET, NW, BOX IP, WASHINGTON, DC, 20007, US

(73) Assignee: Fujitsu Limited

(21) Appl. No.: 11/020,358

(22) Filed: Dec. 27, 2004

(30) Foreign Application Priority Data
Sep. 17, 2004 (JP) 2004-271021

(51) Int. Cl. H04B 7/00; H04B 7/212

(52) U.S. Cl. 370/338; 370/347; 455/509

(57) ABSTRACT

Disclosed is a wireless network system with a plurality of wireless terminals and at least one communication apparatus. The system is adapted for indirect communication of the wireless terminals via a network or direct communication among the wireless terminals themselves. In the system, the communication apparatus prepares setting information necessary for the direct communication, and transmits it to the individual wireless terminals via the network. The individual wireless terminal, on receiving the setting information, starts the direct communication based on the setting information.

### BACKGROUND OF THE INVENTION

1. Field of the Invention

The present invention relates to a wireless terminal for radio communication, and a communication apparatus for exchanging communication information with the wireless terminal. Moreover, the present invention relates to a wireless network system having multiple wireless terminals and at least one communication apparatus, and a communication method for the wireless network system.

2. Description of the Related Art

A wireless LAN has been widely used as a communication medium for business enterprises or household in addition to a conventional wired LAN (Local Area Network). Communication devices “access point” are increasingly installed even in public spaces such as a station or an airport, a hotel, and a coffee shop. Around the access points, appeared are public wireless LAN services that enable the Internet connection.

The wireless LAN has the advantages, which the wired LAN has not, that no cable laying is needed for communication, and within the same wireless area of the access point, users of the wireless terminals enjoys communication without regard to specific-site to be available for communication.

The conventional wireless LAN suffered from such disadvantages as low transmission speed, limited user satisfaction only with the transmission of lower data capacity, for such use as Web browsing or mail transmission. Recent wireless LAN enjoys improved technique, enabling its high-speed communication comparable to the wired LAN.

Recently, appeared on wireless LAN field are a portable terminal that adds operational support for a wireless LAN, and a dual terminal in which a cellular phone and the wireless LAN are equipped. These terminals enable VoIP (Voice over Internet Protocol) available for the wireless LAN. Accordingly, the wireless LAN has been used in various cases.

To perform communication through a wireless LAN, a wireless terminal is to be set to either an infrastructure mode or an ad hoc mode.

In an infrastructure mode, communication is performed such that a wireless terminal is connected to the access point as a gateway for another network, through a repeater, such as a router inside a network, the terminal can connect with a communication device of another network. As the wireless LAN communication method, defined are a CSMA/CA (Carrier Sense Multiple Access with Collision Avoidance) method that performs a carrier sense, and a polling method by which the access point manages data sending.

On the contrary, in an ad hoc mode, wireless terminals themselves form an ad hoc network to thereby communicate with only the wireless terminal inside the ad hoc network. A wireless terminal described in a Non-patent document 1 operates as a repeater to thereby construct a multi-hop type ad hoc network.

Neither an infrastructure mode nor an ad hoc mode can be used simultaneously. For example, when a wireless terminal sets the ad hoc mode, communication in the infrastructure mode is impossible. Accordingly, the wireless terminal in a wireless LAN is usually connected to an access point in the infrastructure mode in order to communicate with a communication device of the Internet or another network.

However, communication in an ad hoc mode does not pass through such a repeater as an access point. Accordingly, the communication is effective in that: the delay of communication data is reduced, the bandwidth between wireless terminals in communication can be used sufficiently, and a load in the repeater can be reduced. Incidentally, in the portable remote terminal having operational support for the wireless LAN or dual terminal, it is hard to assume that the user uses multiple applications simultaneously. Thus, the terminal that operates such a single application should preferably perform the communication in the ad hoc mode if the communication in the ad hoc mode is available for between the terminals themselves.

In the ad hoc mode, like in the infrastructure mode, the connection to other wireless terminals requires the setting of; an SSID (Service Set ID) that is a network identification value and a key (e.g. WEP) used for authentication and cryptographic communication. If wireless terminals that communicate among themselves in the ad hoc mode communication have no setting for the same SSID and key as the other side terminal, the communication between them is impossible.

A first technical problem about the related art is that users of the wireless terminal manually need to set the ad hoc mode, costing inconvenience.

A second technical problem about the related art is as follow. As described above, a wireless terminal is connected to an access point usually in an infrastructure mode. Even if one wireless terminal in communication is switched to the ad hoc mode, when the other wireless terminal enters the infrastructure mode, the communication in the ad hoc mode cannot be performed. Accordingly, for communication in the ad hoc mode, two users need to consciously select a suitable mode with each other.

A third technical problem about the related art is as follow. In communication in an ad hoc mode, users need to perform such setting for security as that of a cryptographic key. In the setting, such things often happen as the key setting is not performed, or a simple key is performed that is easily estimated by malicious third parties, causing the security to be inferior.

A Patent document 1 discloses a technique having a predetermined radio communication system. The arrangement of the system is as follows. Before communication, two radio stations (a first and second radio stations) exchange each other's information on its radio communication method. If the first radio station does not have the communication software of the second radio station, the second radio station transmits its communication software to the first radio station, and thereby deciding an appropriate communication method between the two radio stations. In this communication method, however, in order to perform direct communication, each of radio stations need to make conscious efforts to determine whether direct communication is available between them. In this case where direct communication is unavailable, some radio station mistakenly perform the operation for the direct communication. The Patent document 1 has the problem of this.

A Patent document 2 discloses the technique wherein radio communication apparatuses (a first and second radio communication apparatuses) make a link connection to communicate with each other. The arrangement of the system is as follows. Before communication, the first communication apparatus establishes a link connection with a second radio communication apparatus via an access point. The first communication apparatus confirms whether direct communication is available with this second radio communication apparatus. If available, the direct communication between these apparatuses is performed. This Patent document 2, however, also suffers from that one radio communication apparatus, before communication with the other radio communication apparatus, needs to be conscious of the other radio communication apparatus. In this case, because all the radio communication apparatuses connected to the access point encrypt data using the same key, the data might be disadvantageously tapped from another radio communication apparatus connected to the same access point. Accordingly, the radio communication apparatus has a problem of security. (Note: In both the Patent document 1 and the Patent document 2, the user does not set data, but a wireless terminal sets the data automatically.)
Non-patent document 1: <URL:http://www.skyley.com/index.html>, [online] [Retrieved on Jul. 14, 2004]
Patent document 1: International Publication No. WO01/048997
Patent document 2: Japanese Patent Application Laid-open No. 348103/2003

### SUMMARY OF THE INVENTION

An object of the present invention is to provide a wireless network technique that can realize an ad hoc mode in which wireless terminals perform direct communication among themselves with excellent convenience without forcing a user's troublesome operation.

Another object of the present invention is to provide a wireless network technique that can realize an ad hoc mode in which wireless terminals perform direct communication in which two users does not need to consciously select a suitable mode with each other.

Still Another object of the present invention is to provide a wireless network technique that can realize an ad hoc mode in which wireless terminals perform direct communication among themselves with enhanced security.

A first aspect of the present invention resides in a wireless network system with a plurality of wireless terminals and at least one communication apparatus, the system being adapted for indirect communication of the wireless terminals via a network (referred to as indirect communication, hereinafter) or direct communication among the wireless terminals themselves (referred to as direct communication, hereinafter).

In the system, the communication apparatus has a function of preparing setting information necessary for the direct communication, and transmitting the setting information to the individual wireless terminals via the network.

In the system, the individual wireless terminal has
a function of, on receiving the setting information, starting the direct communication based on the setting information.

A second aspect of the present invention resides in a communication method of a wireless network system with a plurality of wireless terminals and at least one communication apparatus, the system being adapted for indirect communication or direct communication.

The method has a step wherein the communication apparatus prepares setting information on direct communication, and transmits the setting information to the individual wireless terminals via the network;
a step wherein the wireless terminals, on receiving and referring to the setting information, chooses between the direct communication and the indirect communication depending on whether the direct communication is available or not.

A third aspect of the present invention resides in a communication apparatus served for the access from a plurality of wireless terminals via a network, having:
a storage unit that stores information about a wireless terminal in response to a registration request from the wireless terminal;
a monitoring unit that monitors communication of the wireless terminals registered in the storage unit, and detects indirect communication;
a preparation unit that prepares setting information for direct communication as soon as the indirect communication is detected by the monitoring unit; and
a transmitting and receiving control unit that transmits the setting information to the wireless terminals in indirect communication and to prompts the terminal to transfer to the direct communication.

A fourth aspect of the present invention resides in a wireless terminal for indirect communication or direct communication, having:
a receiving unit that receives setting information on the direct communication, the setting information being transmitted from a communication apparatus via the network; and
a communication unit that performs the direct communication based on the received setting information.

A fifth aspect of the present invention resides in a signal with a communication control program served for controlling a communication apparatus being accessed from a plurality of wireless terminals via a network, wherein the program allows the communication apparatus to realize:
a function of monitoring communication of the wireless terminals in connection and detecting the start of indirect communication; and
a function of, on detecting the indirect communication, preparing setting information for the direct communication, and transmitting the setting information to the wireless terminals.

A sixth aspect of the present invention resides in a signal with a terminal control program served for controlling a wireless terminal, wherein the program allows the wireless terminal to realize:
a function of receiving setting information for direct communication from a communication apparatus and performing the direct communication based on the received setting information.

In the wireless network system of the present invention, the communication apparatus in the system monitors communication among wireless terminals themselves, and prepares and transmits setting information to the wireless terminals as soon as the communication among the wireless terminals is detected. The wireless terminal, on receiving the setting information, starts direct communication based on this setting information.

Accordingly, an individual user need not be conscious of the switching between indirect communication and direct communication, and is freed from a troublesome switching operation.

If necessary, setting information including cryptographic key information enables the wireless terminal on the other side to be authenticated in direct communication. Encrypting communication data utilizing key information even in the direct communication realize high security level communication.

The communication apparatus of the present invention includes, for example, an access point or SIP (Session Initiation Protocol) having the function that can monitor the communication start of a wireless terminal. In the access point, the communication apparatus manages a MAC (Media Access Control) address of the wireless terminal, and in the SIP Server manages an IP (Internet Protocol) address of the wireless terminal.

### BRIEF DESCRIPTION OF THE DRAWINGS

Preferred embodiments of the present invention will be described in detail based on the followings, wherein:

FIG. 1 is a conceptual illustration showing an example of a wireless network system in an embodiment 1 of the present invention;

FIG. 2 is a conceptual illustration showing an example of direct communication among the wireless terminals in the wireless network system in the embodiment 1 of the present invention;

FIG. 3 is a conceptual illustration showing an example of the functional configuration of a communication apparatus in the embodiment 1 of the present invention;

FIG. 4 is a block diagram showing a hardware configuration example of the communication apparatus in the embodiment 1 of the present invention;

FIG. 5 is a conceptual illustration showing an example of an SIP message sent from the communication apparatus to a wireless terminal, in the embodiment 1 of the present invention;

FIG. 6 is a conceptual illustration showing a software configuration example of the wireless terminal in the embodiment 1 of the present invention;

FIG. 7 is a block diagram showing an example of the hardware configuration of the wireless terminal in the embodiment 1 of the present invention;

FIG. 8 is a sequence diagram showing an example of actions of the communication apparatus and the wireless terminal in the embodiment 1 of the present invention;

FIG. 9 is a sequence diagram showing an example of the actions of the communication apparatus and the wireless terminal in the embodiment of the present invention;

FIG. 10 is a sequence diagram showing an example of the actions of the communication apparatus and the wireless terminal in the embodiment 1 of the present invention;

FIG. 11 is a flowchart showing an example of operation of the wireless terminal on the sending side in a wireless network system of the embodiment 1 of the present invention;

FIG. 12 is a flowchart showing an example of the operation of the wireless terminal on the receiving side in the wireless network system of the embodiment 1 of the present invention;

FIG. 13 is a flowchart showing an example of the operation of the communication apparatus (SIP server) in the wireless network system of the embodiment 1 of the present invention;

FIG. 14 is a conceptual illustration showing the configuration example of the wireless network system which is an embodiment 2 of the present invention;

FIG. 15 is a conceptual illustration showing an example of direct communication among the wireless terminals 40 in the wireless network system which is the embodiment 2 of the present invention;

FIG. 16 is a conceptual illustration showing the functional configuration of the communication apparatus in the wireless network system of the embodiment 2 of the present invention;

FIG. 17 is a block diagram showing an example of the hardware configuration of the communication apparatus in the wireless network system of the embodiment 2 of the present invention;

FIG. 18 is a sequence diagram showing an example of an action of the wireless network system of the embodiment 2 of the present invention;

FIG. 19 is a sequence diagram showing an example of the effect of the wireless network system of the embodiment 2 of the present invention;

FIG. 20 is a sequence diagram showing the configuration example of an extended ARP message in the wireless network system of the embodiment 2 of the present invention;

FIG. 21 is a conceptual illustration showing an example of the operation of the wireless terminal on the sending side in the wireless network system of the embodiment 2 of the present invention, together with FIG. 22;

FIG. 22 is a conceptual illustration showing an example of the operation of the wireless terminal on the sending side in the wireless network system of the embodiment 2 of the present invention, together with FIG. 21;

FIG. 23 is a conceptual illustration showing an example of a setting information table provided in the wireless terminal that constructs in the wireless network system of the embodiment 2 of the present invention;

FIG. 24 is a flowchart showing an operation example as the receiving side of the wireless terminal that constructs the wireless network system of the embodiment 2 of the present invention;

FIG. 25 is a flowchart showing the operation example when encrypted data of the wireless terminal that constructs the wireless network system of the embodiment 2 of the present invention is received;

FIG. 26 is a conceptual illustration showing the configuration example of information on a MAC frame in the wireless network system of the embodiment 2 of the present invention;

FIG. 27 is a conceptual illustration showing setting contents of the MAC frame in the wireless network system of the embodiment 2 of the present invention, when compared between communication via a network and direct communication; and

FIG. 28 is a flowchart showing an example of the actions of the communication apparatus in the wireless network system of the embodiment 2 of the present invention.

### DESCRIPTION OF THE PREFERRED EMBODIMENTS

The embodiments of the present invention are described in detail below with reference to the drawings.

### Embodiment 1

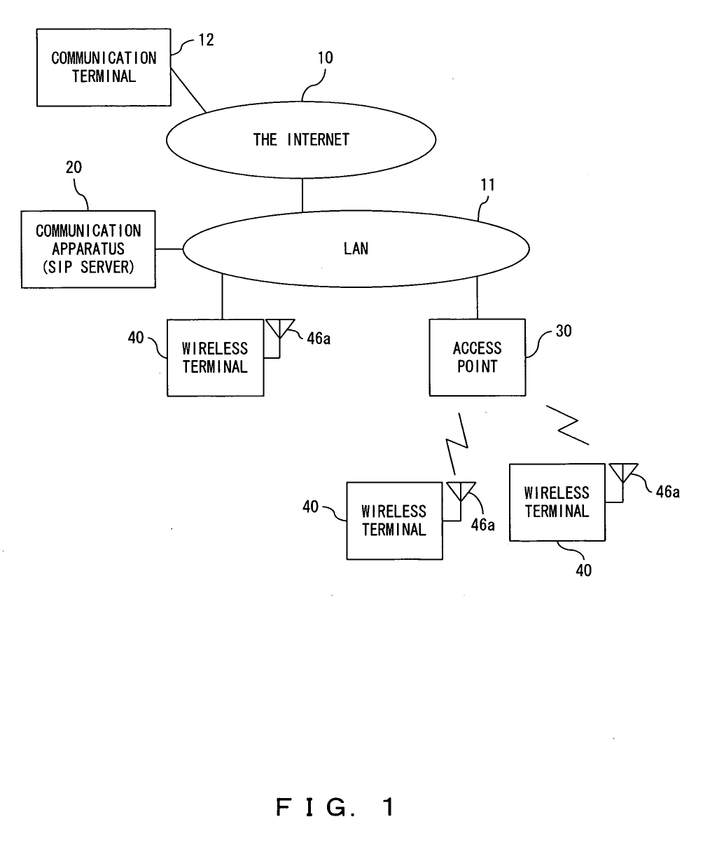

FIG. 1 is a conceptual illustration of a wireless network system in an embodiment 1 of the present invention. As shown in FIG. 1, the wireless network system in the embodiment 1 of the present invention includes a LAN 11 connected to the Internet 10, a communication apparatus 20 (SIP server) connected to this LAN 11, an access point 30 (AP), and multiple wireless terminals 40 that perform radio communication with this access point 30. Part of the wireless terminals 40 is also connected to the LAN 11. A communication terminal 12 is connected to the Internet 10.

The wireless terminals 40 enable communication by a multimedia application, such as VoIP (Voice over IP) or a video phone, with another wireless terminal 40 that uses SIP. The wireless terminal 40 in the embodiment 1 of the present invention may even be equipped with another communication media, such as a wired or cellular phone, as well as a wireless LAN function. However, the wireless terminal must be registered in the communication apparatus 20 using any access line.

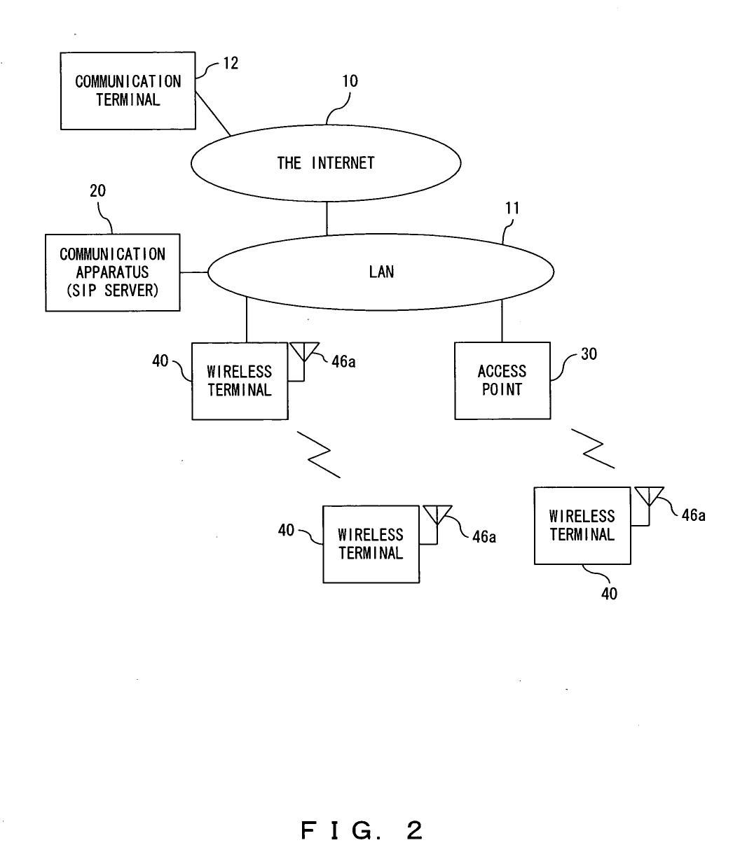

FIG. 2 is an example of direct communication among the wireless terminals themselves 40 in the wireless network system of the embodiment 1 of the present invention. According to the embodiment 1 of the present invention described later, the wireless terminals 40 registered in the communication apparatus 20 can also perform the direct communication among themselves without through the access point 30.

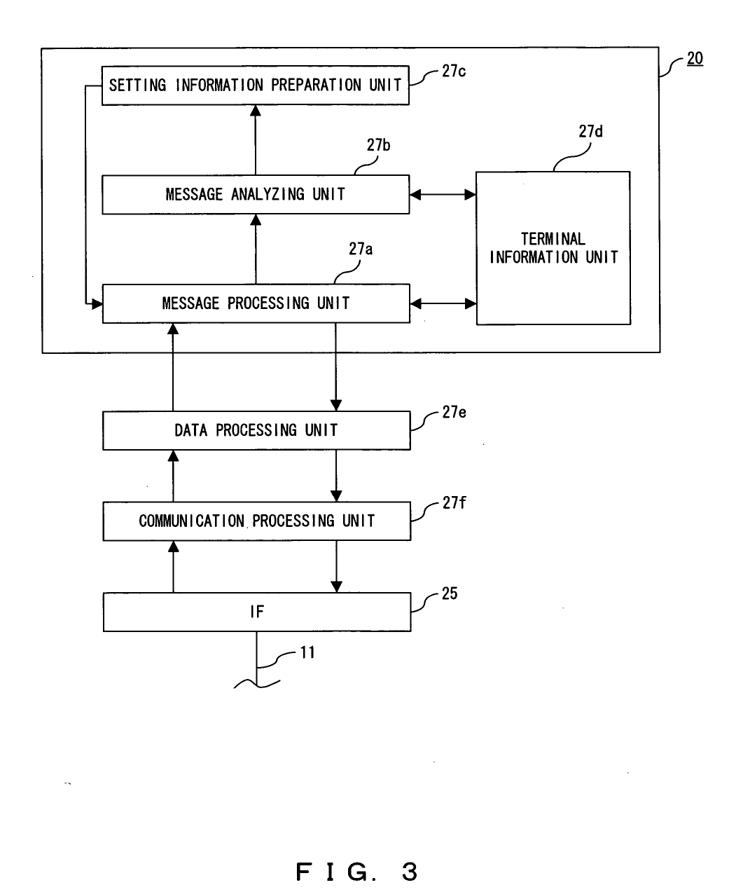

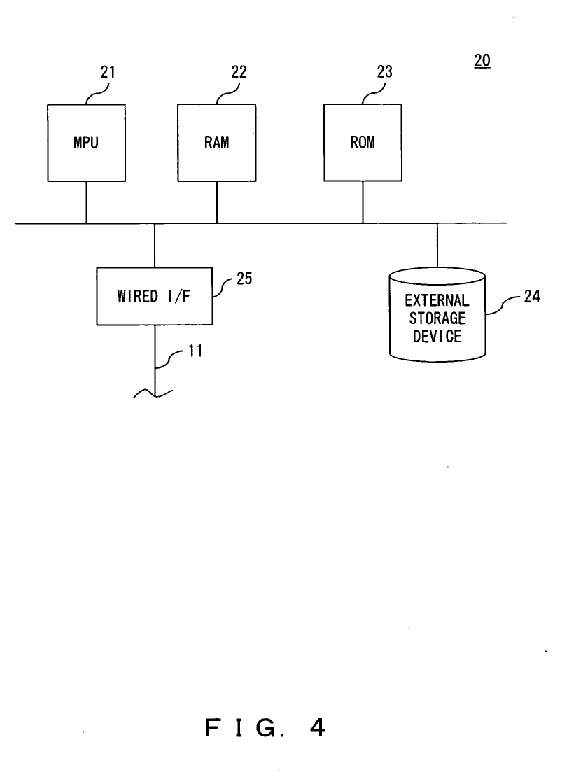

FIG. 3 is a conceptual illustration showing an example of the functional configuration of the communication apparatus 20 in the embodiment 1 of the present invention. FIG. 4 is a block diagram showing the hardware configuration example.

As shown in FIG. 4, the communication apparatus 20 of this embodiment 1 includes a processor 21 that controls the whole system, a main storage 22 and a read only memory 23 that store programs and data that this processor 21 executes, an external storage device 24, and a wired communication interface 25 for being connected to the LAN 11.

The communication apparatus 20 of this embodiment 1 includes a program for implementing each function of a message processing unit 27a, a message analyzing unit 27b, a setting information preparation unit 27c, a terminal information unit 27d, a data processing unit 27e, and a communication processing unit 27f. Each of these programs is stored in the read only memory 23 and the external storage device 24. If necessary, the programs are read out from the main storage 22, and each function is implemented by executing each program by the processor 21. Otherwise, each program is stored in the read only memory 23, and each function may also be implemented by allowing the processor 21 to read each program from this read only memory 23.

The communication processing unit 27f and the data processing unit 27e perform predetermined protocol processing in communication with a communication apparatus through the wired communication interface 25.

The message processing unit 27a controls message transmission between itself and the wireless terminal 40. The terminal information unit 27d stores information about the wireless terminals 40 that the communication apparatus 20 recognizes. The message analyzing unit 27b analyses a message of the wireless terminal 40. When the communication among the wireless terminals 40 inside a wireless network system is detected based on the terminal information stored in this message analyzing unit 27b and the terminal information unit 27d, the setting information preparation unit 27c prepares setting information on the direct communication among the wireless terminals themselves 40, and transmits the setting information to the corresponding wireless terminals.

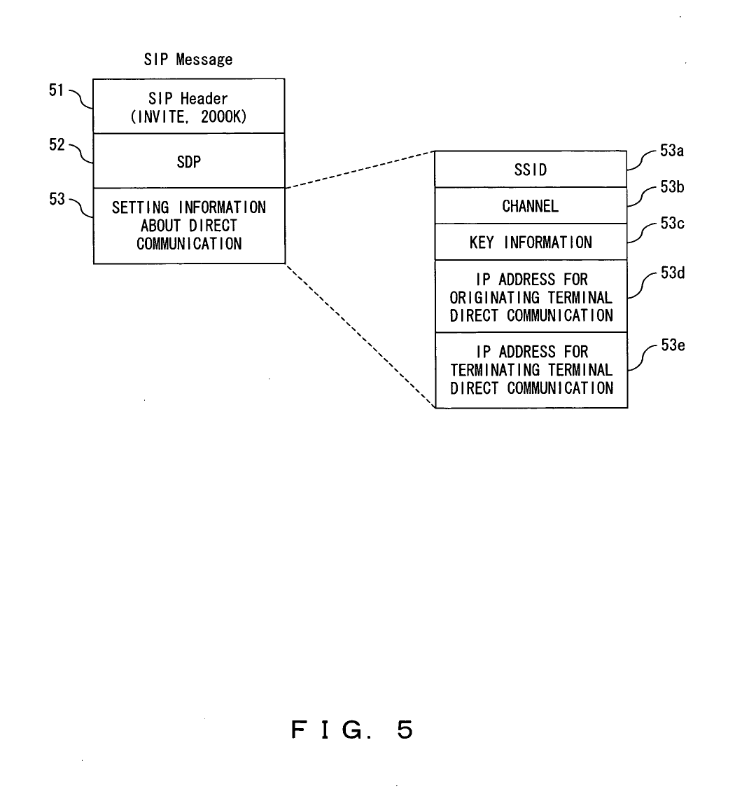

That is, FIG. 5 is a conceptual illustration showing an example of an SIP message 50 sent from the communication apparatus 20 to the wireless terminal 40. The SIP message 50 includes an SIP header 51 that stores information indicating a message type, and SDP (Session Description Protocol) 52 to which a session parameter is written. In case of this embodiment 1, setting information 53 is added behind this SDP 52 and sent to the wireless terminal 40. This setting information 53 includes an SSID 53a for identifying a session, a channel 53b that indicates a path to be used in direct communication, key information 53c, an IP address 53d of sending side terminal for direct communication, and an IP address 53e of receiving side terminal for direct communication.

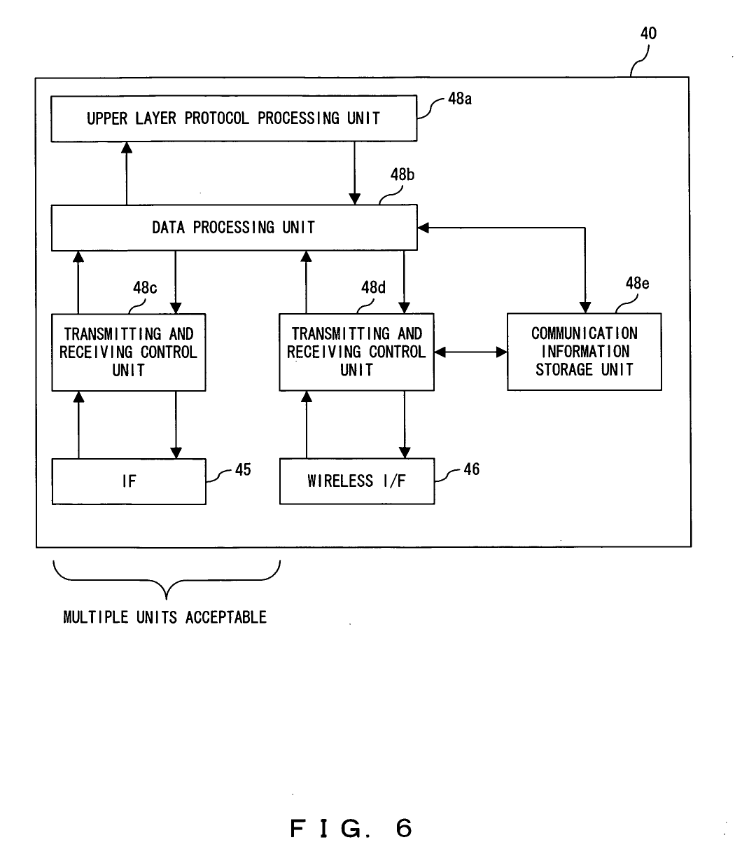

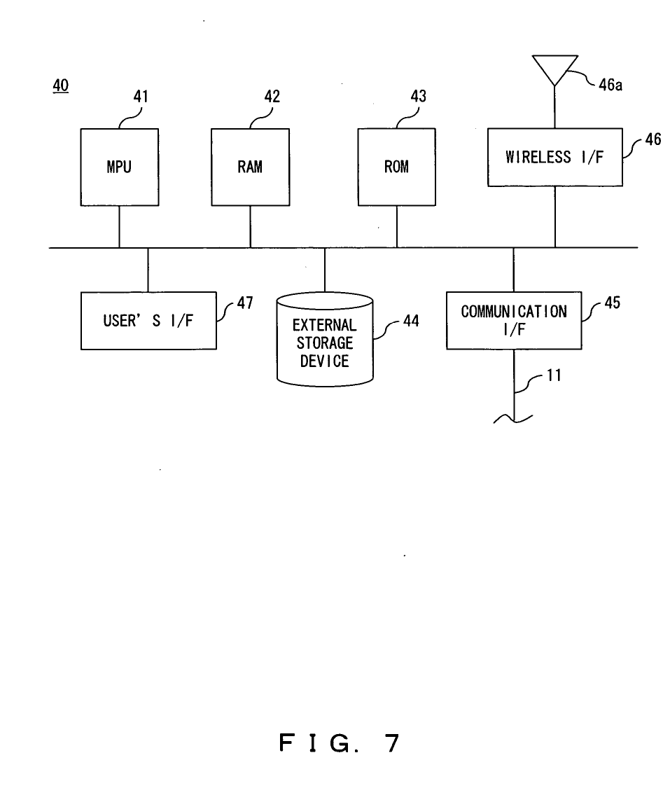

FIG. 6 is a conceptual illustration showing a software configuration example of a wireless terminal of this embodiment 1. FIG. 7 is a block diagram showing an example of its hardware configuration.

As shown in FIG. 7, the wireless terminal 40 of this embodiment includes a processor 41 that controls the whole system, a main storage 42 and a read only memory 43 that store programs and data that this processor 41 executes, an external storage device 44, a wireless interface 46 and an antenna 46a for performing communication through a wireless LAN, one or multiple communication interfaces 45 for performing communication using a wired LAN or other various communication media (PHSs), and a user's interface 47.

As shown in FIG. 6, the wireless terminal 40 includes a transmitting and receiving control unit 48c that controls communication by the communication interface 45, a data processing unit 48b that transmits information by the wireless interface 46 between these transmitting and receiving control unit 48c and the transmitting and receiving control unit 48d. The wireless terminal 40 also includes an upper layer protocol processing unit 48a for performing the processing of the upper layer of communication protocol in the communication interface 45 or the wireless interface 46, and a communication information storage unit 48e for storing the setting information 53 that is included in the SIP message 50 and arrived from the communication apparatus 20.

The wireless terminal 40 acquires the setting information 53 of another wireless terminal 40 by the data processing unit 48b, and stores the information in the communication information storage unit 48e. The transmitting and receiving control unit 48d controls direct communication using the wireless interface 46 with another wireless terminal 40 based on the setting information 53 stored in the communication information storage unit 48e.

The communication method among wireless terminals in the wireless network system of this embodiment 1 is described.

<Registration Phase>

First, the individual wireless terminal 40 registers in the communication apparatus 20.

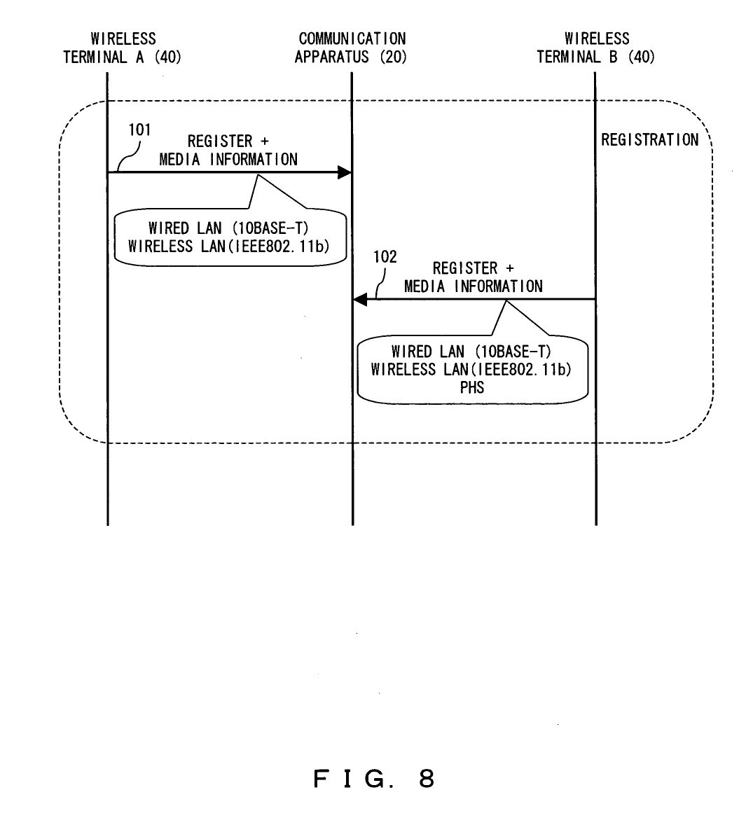

As shown in FIG. 8, when the wireless terminal 40 that desires to establish a connection with other side terminal uses the communication apparatus 20, the terminal 40 need to be registered at the communication apparatus 20 before the communication (step 101). At this time, communicable media information is written to a registration message (REGISTER message). For example, when the wireless terminal 40 (A) equipped with the media for a wired LAN and a wireless LAN registers in the communication apparatus 20 through the wired LAN, communication media information, such as IEEE 802.3 (wired LAN) or IEEE 802.11b (wireless LAN), is written to the REGISTER message.

In case of the wireless terminal 40 (B) of FIG. 8, the media information on a PHS (Personal Handy Phone System) the wireless terminal 40 (B) has is also included in the REGISTER message in addition to IEEE 802.3 (wired LAN) or IEEE 802.11b (wireless LAN) (step 102).

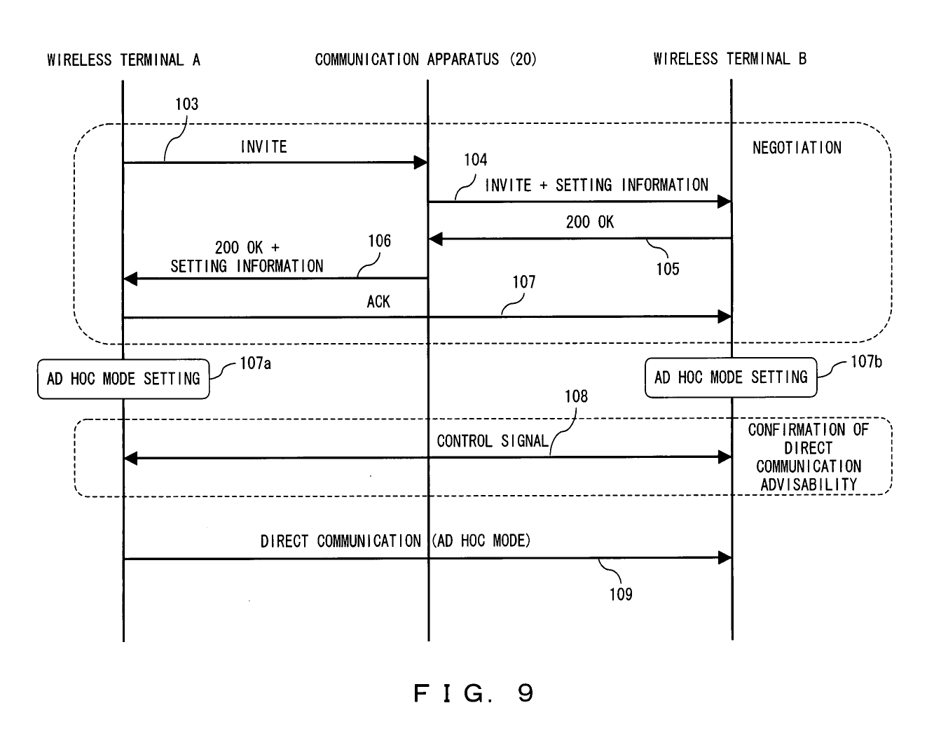

The communication method among wireless terminals in direct communication is described with reference to FIG. 9.

<Negotiation Phase>

The wireless terminal 40 (A) whose session is desired to be established sends an INVITE message to the wireless terminal 40 (B) of the other side via the communication apparatus 20 (step 103).

At this time, the communication apparatus 20 determines whether direct communication is possible in both the terminals based on the communication media information and address information that are registered. When the direct communication is determined to be possible in both the terminals, an INVITE message is sent to the wireless terminal 40 (B) together with setting information (step 104).

The wireless terminal 40 (B) of the other side that received this INVITE message returns 200 OK message to the wireless terminal 40 (A) via the communication apparatus 20 when the direct communication is possible (step 105).

The communication apparatus 20 that received the 200 OK message adds setting information, and transmits the setting information to the wireless terminal 40 (A) of the sending side (step 106).

When the wireless terminal 40 (A) of the sending side enables direct communication, an ACK message is sent to the wireless terminal 40 (B) of the other side (step 107).

The wireless terminal A and the wireless terminal B set received setting information (step 107a).

<Direct Communication Advisability Confirmation Phase>

At this time, the wireless terminal A and the wireless terminal B check the possibility of arrival of a control signal in an ad hoc mode (step 108), and start direct communication in case the control signal can arrive (step 109).

<Direct Communication Phase>

In this step 109, the wireless terminals in direct communication mutually authenticate the partner terminal from setting information and encrypt the communication data.

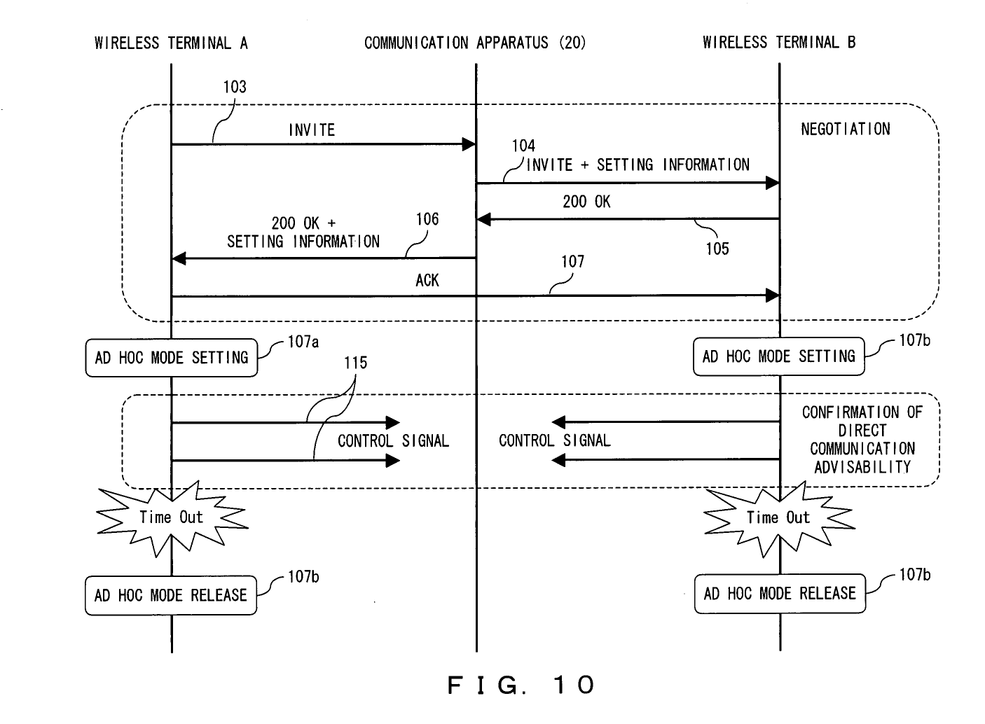

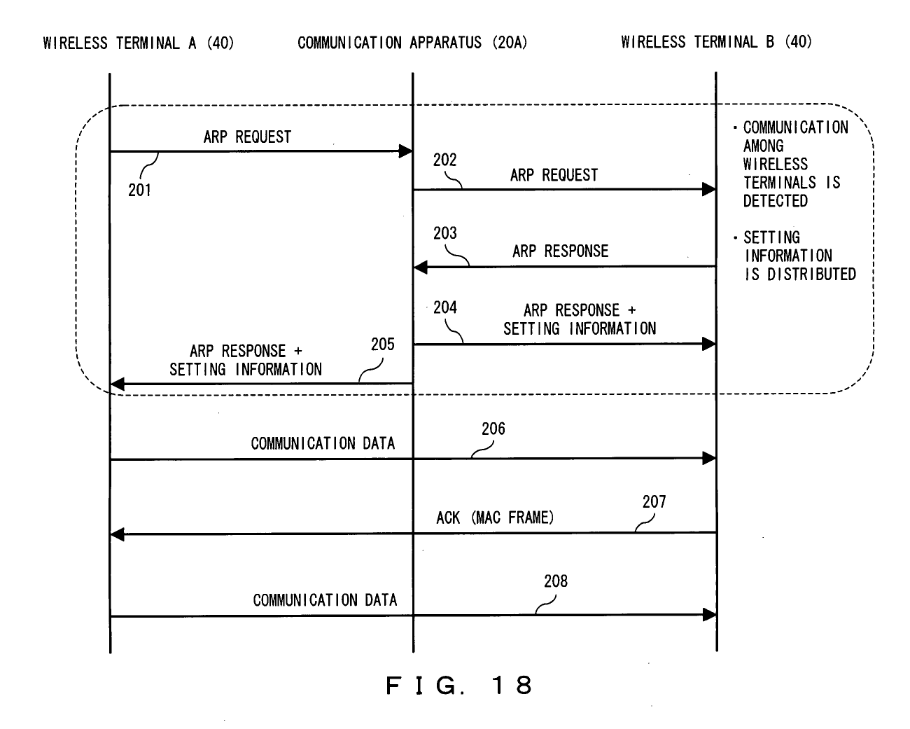

FIG. 10 is a sequence diagram when direct communication is impossible among wireless terminals. The wireless terminal 40 of the receiving side first attempts the direct communication. When the direct communication is determined to be impossible, the direct communication is switched to communication via a network (step 107b). Because the up to the setting of the direct communication is the same as FIG. 18 described later, the steps are not described. Steps 103 to 107a are the same as the aforementioned FIG. 9.

<Normal Communication Phase>

When a message is not delivered, or when the authentication of the wireless terminal 40 of the other side failed, the wireless terminal 40 of the sending source starts communication using the communication media used when communication data is registered in the communication apparatus 20. For example, when registered the communication data using a wired medium, the communication by the wired medium is started (step 107b).

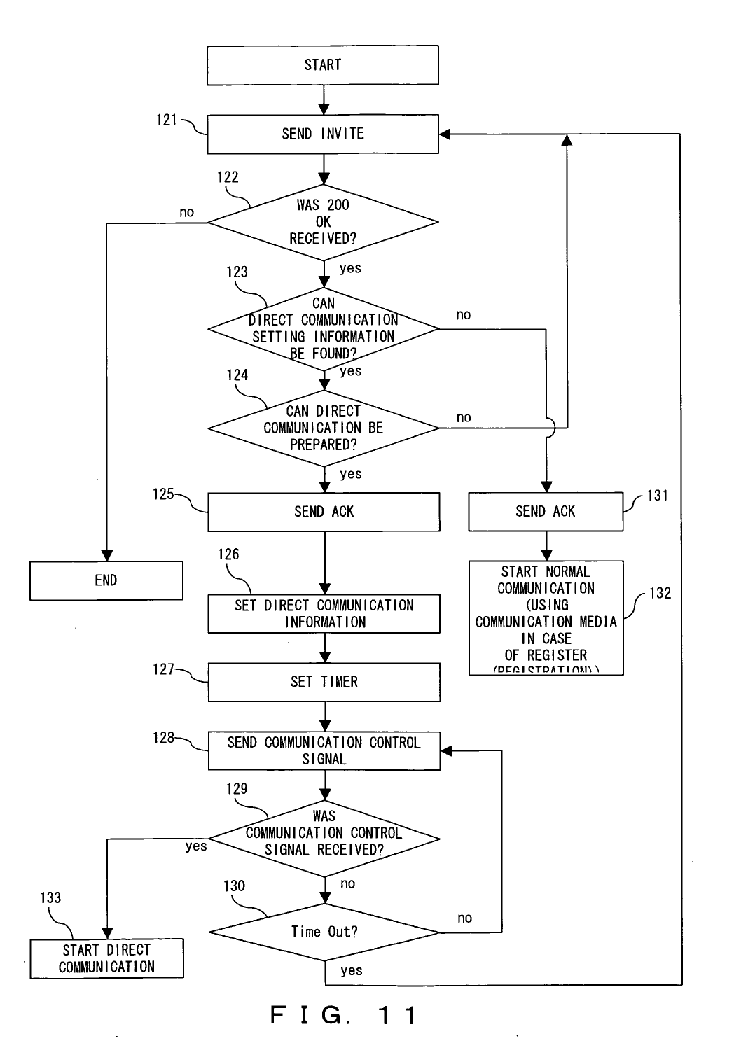

FIG. 11 is a flowchart showing the operation of the wireless terminal 40 (A) of the sending side in the communication sequences of FIGS. 9 and 10. The wireless terminal A sends an INVITE message to the wireless terminal B of the other side when normal communication is started (step 121), and receives 200 OK message from the other wireless terminal B (step 122). At this time, when setting information is included together with the 200 OK message (step 123), the wireless terminal A of the sending side determines whether the preparation of direct communication is possible (step 124). If possible, an ACK message is sent to the wireless terminal B of the other side (step 125). If impossible in the step 124, the INVITE message is sent to the wireless terminal B of the other side via the communication apparatus 20 again (step 121).

The wireless terminal A of the sending side that sent an ACK message sets direct communication information (step 126) and sets a timer (step 127). The wireless terminal A sends a communication control signal (step 128) and switches into an ad hoc mode based on setting information. At this point, when the control signal is received from the wireless terminal B of the other side (step 129), the direct communication is determined to be possible, and communication is started in the ad hoc mode (step 133).

When a control signal is not received from the wireless terminal B of the other side within the timer setting time of step 127 (step 130), the direct communication is determined to be impossible. An INVITE message is sent again (steps 121 to 123), or normal communication is started using the communication media when communication data is registered in the communication apparatus 20 (steps 131 and 132).

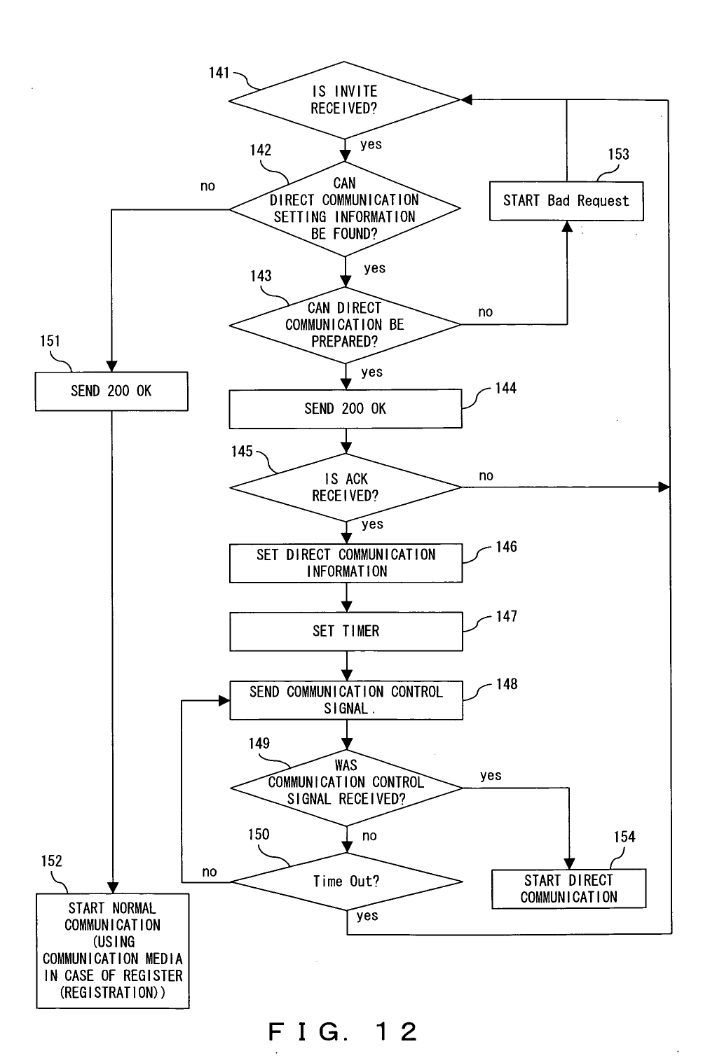

FIG. 12 is a flowchart showing the operation of the wireless terminal B of the receiving side in the same manner. The wireless terminal B that received an INVITE message (step 141) checks whether setting information is included in the INVITE message (step 142). At this point, when the setting information is not included, normal SIP operation is performed (steps 151 and 152). When direct communication information is included in the INVITE message, whether the preparation of the direct communication is possible is determined (step 143). If possible, the 200 OK message is sent to the communication apparatus 20 (step 144). When impossible, “Not Acceptable” is returned to the communication apparatus 20 (step 153). The wireless terminal B that sent the 200 OK message waits for an ACK message arriving from the wireless terminal A of the sending side (step 145). When the ACK message is received, subsequently, the previously received direct communication information is set (step 146), and a timer is set (step 147). Then the mode is switched to an ad hoc mode, and a communication control signal is sent (step 148). In the same manner as the wireless terminal A of the sending side, when the communication control signal is received (step 149), the direct communication is started (step 154). When the signal is not received within the timer setting time (step 150), the state before the INVITE message is received is returned (step 141). The INVITE message from the wireless terminal A of the sending side or the start of normal communication is awaited.

The wireless terminal A of the sending side and the wireless terminal B of the receiving side in which the direct communication is possible in an ad hoc mode are authenticated mutually using key information included in the direct communication setting information. When the authentication is successful, cryptographic communication is performed. When the authentication failed, the direct communication is switched to normal communication.

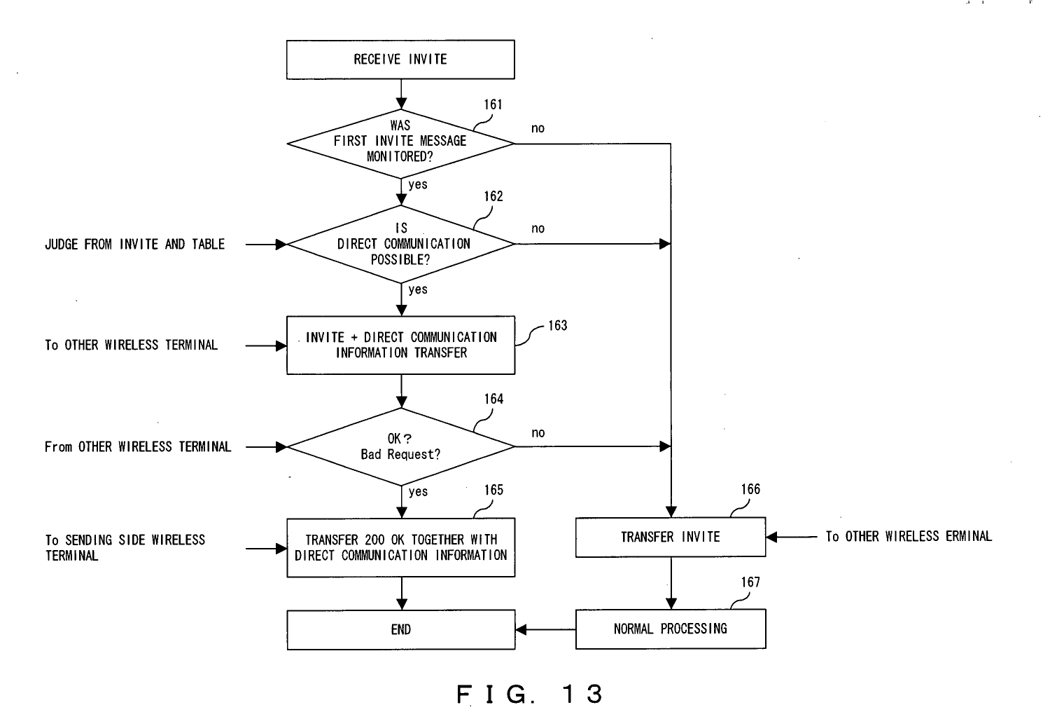

FIG. 13 is a flowchart showing the operation of a communication apparatus (SIP server). The communication apparatus 20 monitors the first INVITE message (step 161), and checks the information about the wireless terminal A of the sending side and the wireless terminal B of the receiving side (step 162) registered in its own table, thereby determining whether direct communication is possible. When the direct communication is determined to be possible, a direct communication instruction message is included in the INVITE message (step 163), and sent to the wireless terminal B of the receiving side. When the direct communication is determined to be impossible, normal transmission is performed (step 166).

Subsequently, the message from the wireless terminal B of the receiving side is awaited. At this point, when 200 OK is returned (step 164), setting information is added to the wireless terminal A of the sending side, and the 200 OK is transmitted (step 165). On the contrary, when “Not Acceptable” is received in the step 164, first, the INVITE message that was received from the wireless terminal A of the sending side is transmitted (step 166), and normal processing is performed (step 167).

When the same INVITE message is received twice or more from the wireless terminal A of the sending side in the step 161, direct communication is determined to be impossible, normal processing is performed (steps 166 and 167).

As described above, according to the embodiment 1, when the communication apparatus 20 such as an SIP server that monitors the state of the communication among the wireless terminals 40 detects the communication among the wireless terminals 40, the communication apparatus 20 transmits the setting information 53 for direct communication to each wireless terminal 40. The wireless terminal 40 that received this setting information 53 performs the direct communication based on the setting information 53. This arrangement frees the user of the wireless terminal 40 from troublesome setting operation for the direct communication that needed every time the user try to make a connection on the conventional system, and yet can realize the direct communication with excellent convenience. At the same time, when a communication load in the LAN 11 is reduced in the direct communication between the wireless terminals 40, the total communication efficiency of a wireless network system can be increased.

The communication apparatus 20 distributes the key information 53c including the key information in direct communication to the wireless terminal 40 that performs the direct communication. Consequently, also in the direct communication by radio, the security having the same level as the communication via a network of the LAN 11 can be maintained.

### Embodiment 2

This embodiment 2 is described quoting, as an example, the case in which a communication apparatus 20A is connected to a wired network 61, and functions as an access point to the wired network 61 of the wireless terminal 40.

That is, the direct communication of this embodiment 2 is not communication in an ad hoc mode. This means that communication data is sent directly to the wireless terminal 40 of the other side without passing through the access point when there is a transmission right in the individual wireless terminal 40 itself over a wireless network 61a the access point (communication apparatus 20A) constructs.

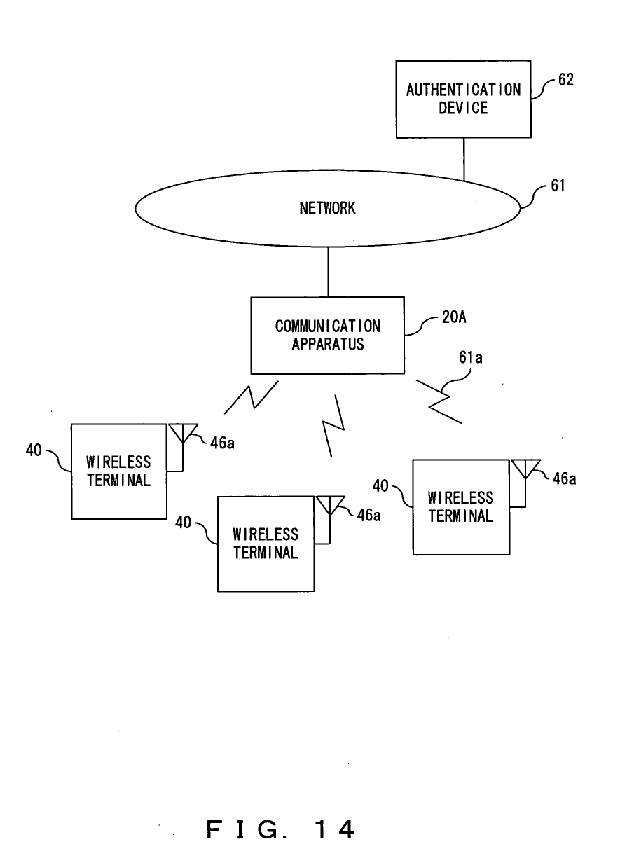

FIG. 14 is an example showing the wireless network system of this embodiment 2. As shown in this FIG. 14, the wireless network system of this embodiment 2 includes the multiple wireless terminals 40 and the communication apparatus 20A, an authentication device 62, and the network 61 that connects these.

The communication apparatus 20A is connected to the network 61. Moreover, the communication apparatus 20A functions as a gateway between the wired network 61 and the wireless network 61a, and the wireless terminal 40 enables connection to a broadband communication network, such as the Internet, via the communication apparatus 20A. The authentication device 62 authenticates the wireless terminal 40 when the wireless terminal 40 is connected to the communication apparatus 20A. When the wireless terminal 40 is valid, the wireless terminal 40 can be connected to the communication apparatus 20A. Moreover, when this authentication is performed, a key for encrypting the communication in the section of the wireless network 61a is assigned to the communication apparatus 20A and the wireless terminal 40. Because the key is assigned dynamically, the wireless terminal 40 that is connected uses a different key respectively. Accordingly, the communication between the wireless terminal 40 that can be connected to the communication apparatus 20A and the communication apparatus 20A cannot be tapped from another wireless terminal 40.

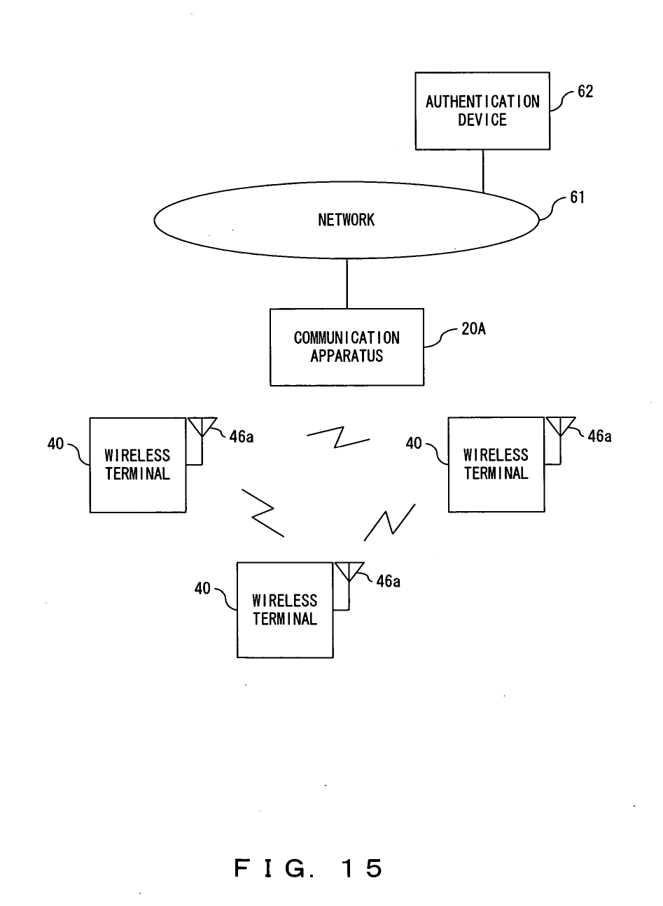

FIG. 15 is an example of the direct communication among the wireless terminals themselves 40 in the wireless network system of this embodiment 2. According to this embodiment 2, the wireless terminals 40 connected to the communication apparatus 20A that is an access point can also perform the direct communication by radio communication without passing through the communication apparatus 20A.

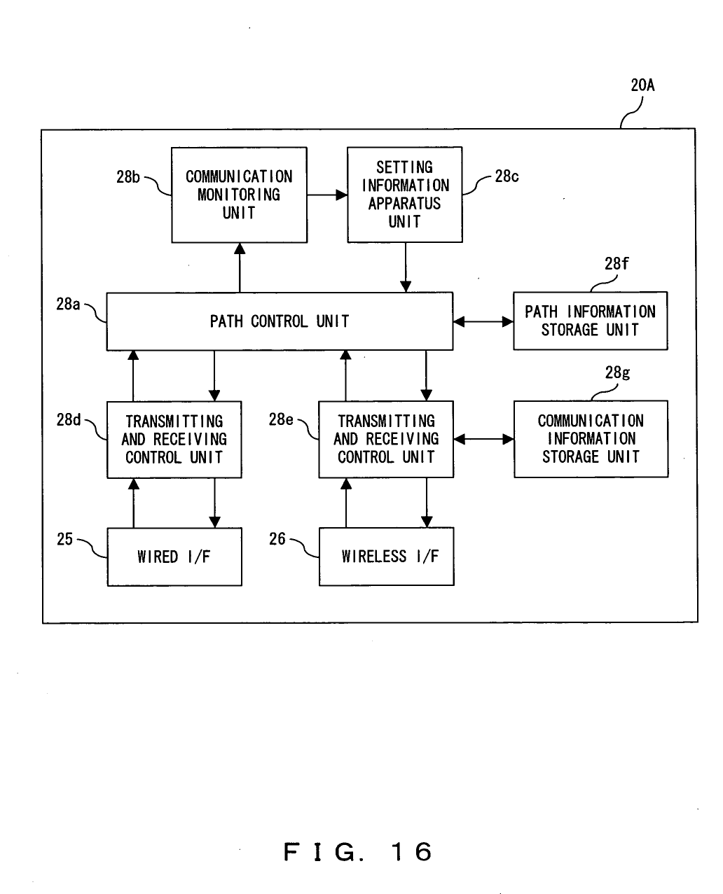

FIG. 16 is a conceptual illustration showing an example of the functional configuration of a communication apparatus in this embodiment 2. The communication apparatus 20A of this embodiment 2 includes a transmitting and receiving control unit 28d that transmits information with the network 61 through the wired communication interface 25 described later, a transmitting and receiving control unit 28e that controls the transmission of the information in the wireless network 61a passing through a radio communication interface 26 described later, and a path control unit 28a that controls an information communication path in the network 61 and the wireless network 61a. The communication apparatus 20A of this embodiment 2 also includes a path information storage unit 28f that stores the path information to be accessed so that the path control unit 28a may perform the path control, a communication monitoring unit 28b for realizing communication between the wireless terminals 40, a setting information preparation unit 28c, and a communication information storage unit 28g that stores setting information for allowing the transmitting and receiving control unit 28e to perform the direct communication between the wireless terminals 40 that passed through the radio communication interface 26.

The communication apparatus 20A in this embodiment 2 includes the communication monitoring unit 28b that monitors the communication of the wireless terminal 40. When this communication monitoring unit 28b detects the communication among the wireless terminals 40, the setting information preparation unit 28c prepares the setting information on the direct communication among the wireless terminals themselves, and transmits the setting information to the corresponding wireless terminal 40.

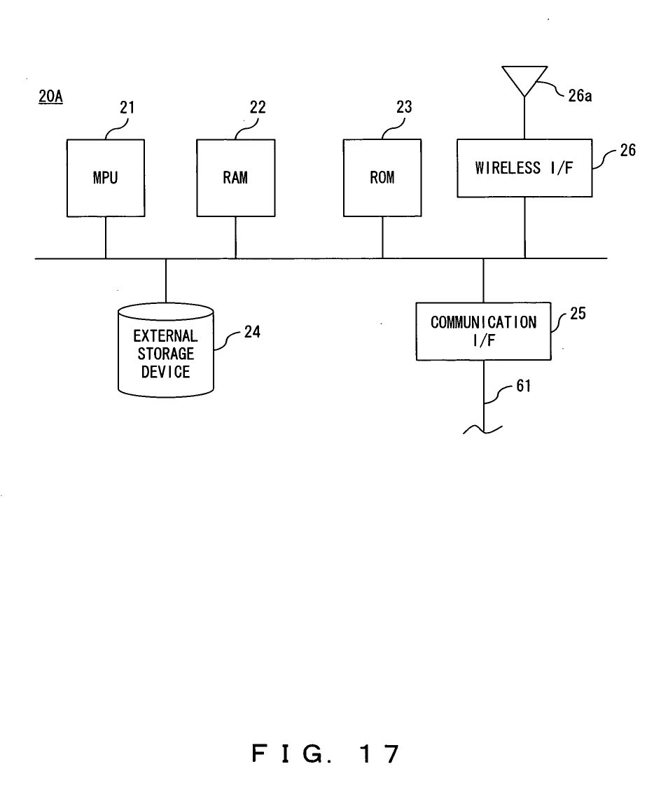

FIG. 17 is a block diagram showing an example of the hardware configuration of the communication apparatus 20A in this embodiment 2. The configuration of FIG. 17 differs from the aforementioned configuration of FIG. 4 in that this communication apparatus 20A includes the radio communication interface 26 for constructing the wireless network 61a between itself and the wireless terminal 40, and an antenna 26a besides the wired communication interface 25 for the wired network 61.

The configuration of the wireless terminal 40 is the same as the configuration of FIG. 6 illustrated in the aforementioned embodiment 1. That is, the wireless terminal 40 allows the data processing unit 48b to acquire setting information from the communication apparatus 20A, and store the setting information in the communication information storage unit 48e. The wireless terminal 40 allows the transmitting and receiving control unit 48d to control communication based on the setting information stored in the communication information storage unit 48e.

Information, such as key information in the direct communication between the wireless terminals 40, is written as setting information. The key information can also use a communication value when communication passed through the communication apparatus 20A. However, for example, in order to enhance security in an enterprise, a different key is frequently assigned to each of the multiple wireless terminals 40, as described in the authentication of IEEE 802.1x. In this case, preferably, new key information should be distributed in the direct communication.

At this point, FIG. 18 shows a communication sequence when the wireless terminals 40 perform direct communication in the wireless network 61a described previously.

The wireless terminal 40 (A) broadcasts an ARP (Address Resolution Protocol) request to obtain a MAC address of the wireless terminal 40 of the other side (step 201). The ARP resolves a physical MAC address from a logical IP address.

The communication apparatus 20A transmits an ARP request to another wireless terminal 40 connected to the communication apparatus 20A (step 202).

The wireless terminal B of the other side that corresponds to an ARP request returns an ARP response (step 203).

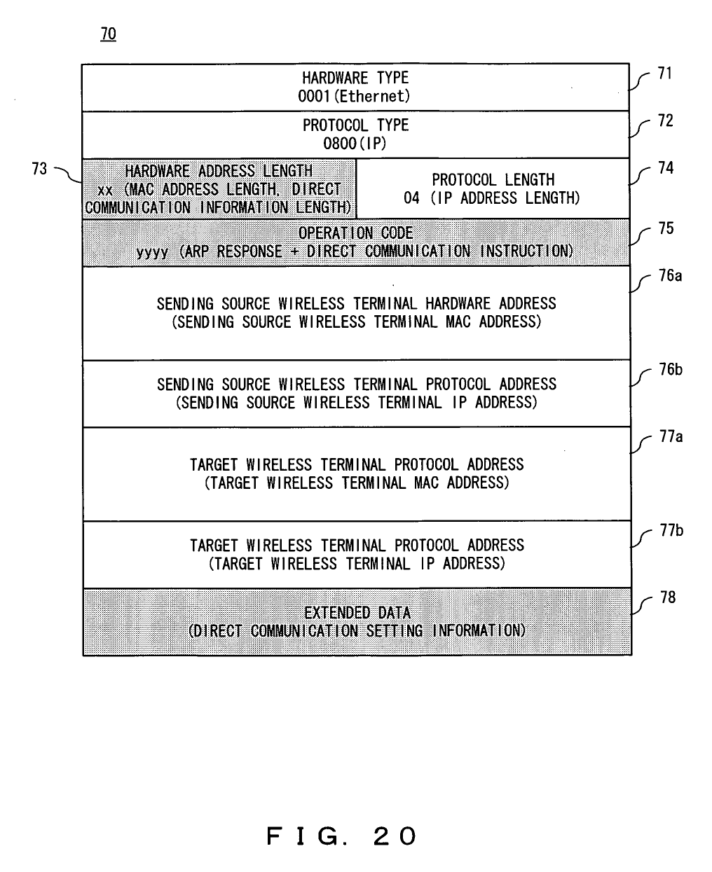

The communication apparatus 20 detects the communication among the wireless terminals 40 in the transmission of the steps 201 to 203, and sends setting information to the wireless terminal A to which an ARP request is sent, and the wireless terminal B to which the ARP response is returned (steps 204 and 205). An instruction message that sends this setting information extends an ARP message, and FIG. 20 shows an example.

That is, as illustrated in FIG. 20, an extended ARP message 70 includes a hardware type 71, a protocol type 72, hardware address length 73, protocol length 74, an operation code 75, a sending source wireless terminal hardware address 76a, a sending source wireless terminal protocol address 76b, a target wireless terminal hardware address 77a, a target wireless terminal protocol address 77b, and extended data 78.

The extended data 78 of this extended ARP message 70 includes setting information, such as key information, in the direct communication between the wireless terminals 40.

The wireless terminals A and B that received the setting information (extended data 78) of the extended ARP message 70 starts direct communication based on the setting information (steps 206, 207, and 208). The communication from the step 201 up to the step 205 is performed via the communication apparatus 20A.

In the direct communication from the step 206 to the step 208, the wireless terminals A and B authenticate the wireless terminal of the remote side mutually and communication is encrypted using the key information included in setting information.

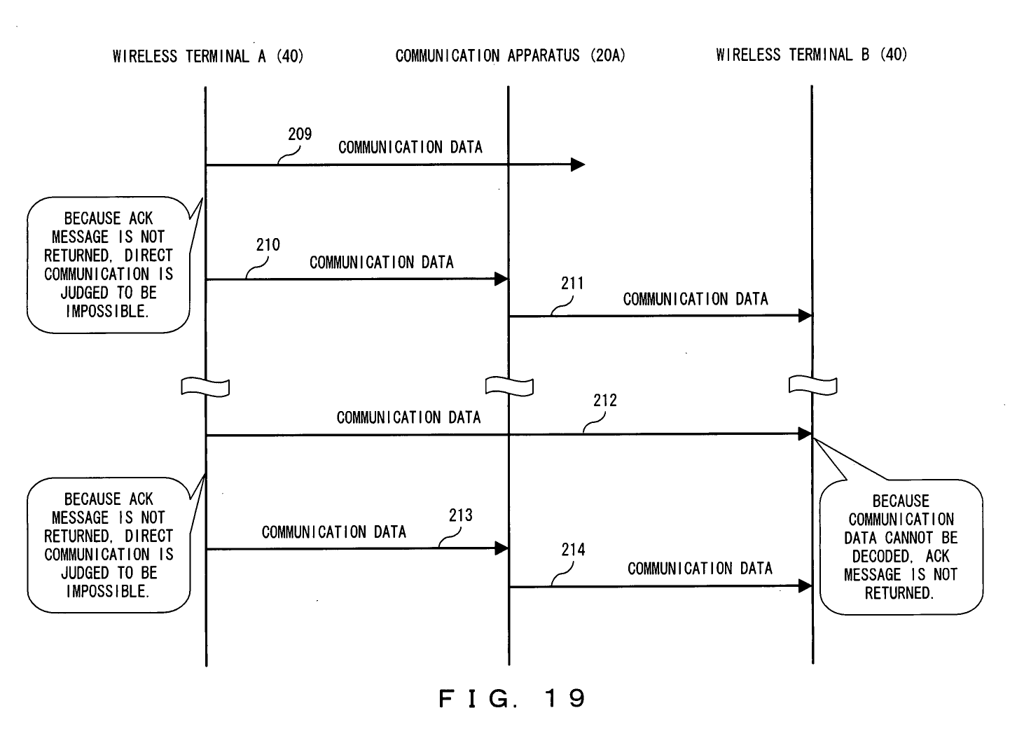

FIG. 19 is a sequence diagram when direct communication is impossible among the wireless terminals. The wireless terminal A of the sending source first attempts the direct communication shown in FIG. 15 (steps 209 and 212). When the direct communication is determined to be impossible, the communication is switched to the communication via the wireless network 61a as shown in FIG. 14 (step 210 to step 211, and step 213 to step 214). Because the steps up to the setting of the direct communication is the same as FIG. 18, the steps are not described.

The step 201 to the step 205 are the same as described previously. When a message is not reached, or when the authentication of the other wireless terminal failed, an ACK message is not returned from the wireless terminal B of the other side to the wireless terminal A of the sending source. Accordingly, the communication is switched to the communication via the wireless network 61a.

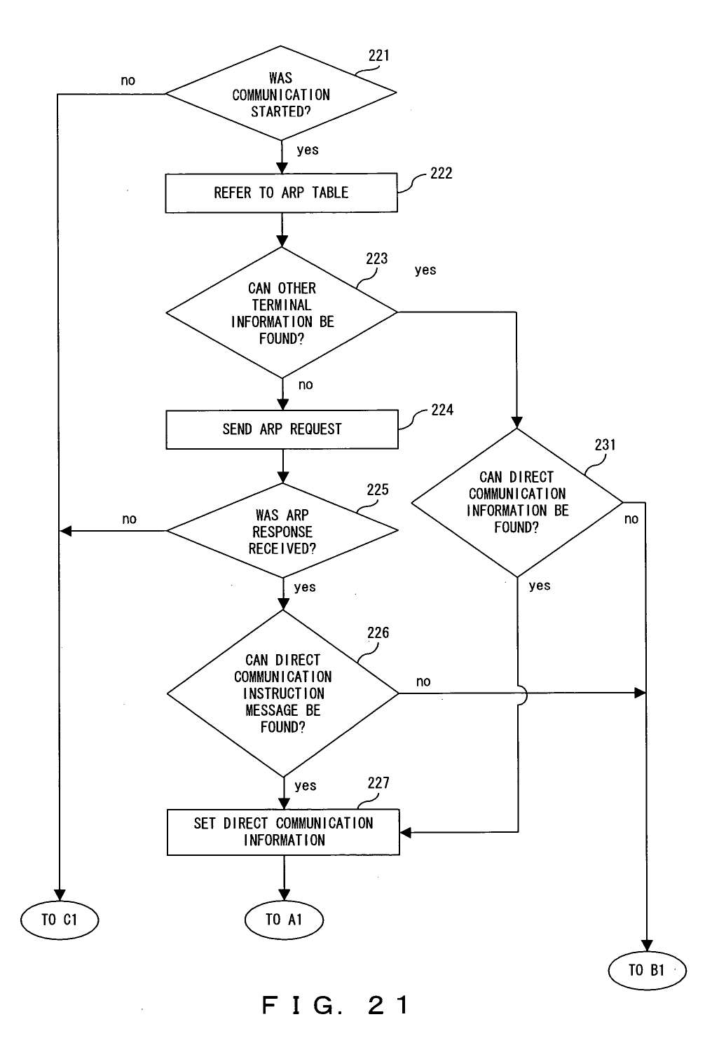

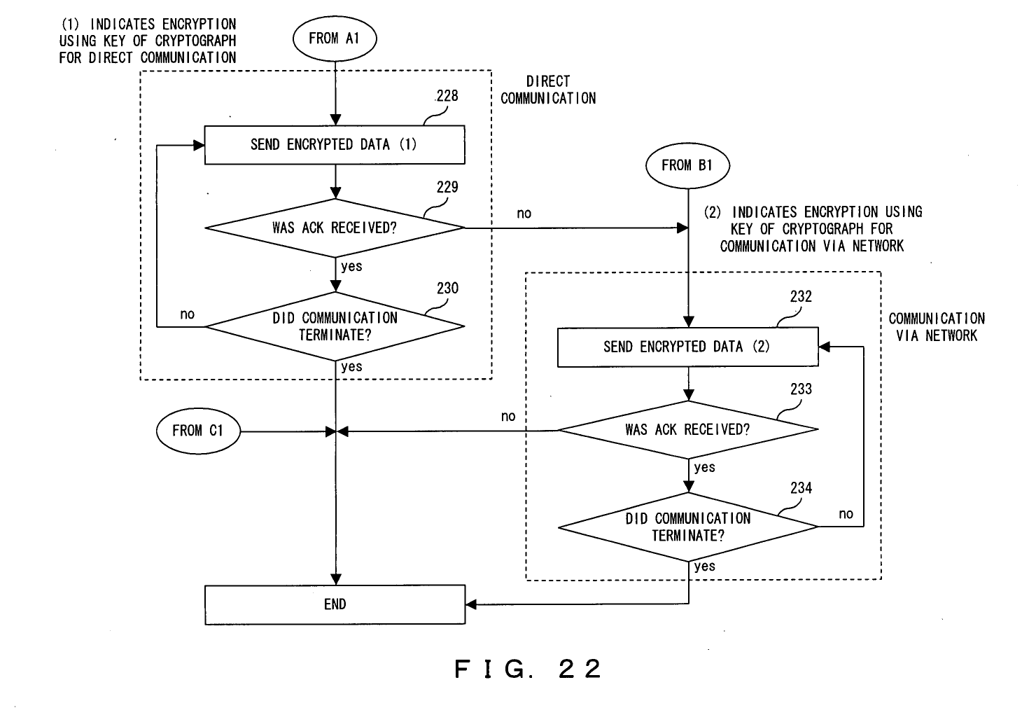

FIGS. 21 and 22 are flowcharts that show the operation of the wireless terminal A of the sending side in the communication sequences of FIGS. 18 and 19. In FIGS. 21 and 22, A1, B1, and C1 show the connection relationships between these flowcharts.

The wireless terminal A usually acquires the MAC address information on a communication party from the information that can be found in its own table when communication starts (step 221) or using an ARP (steps 222, 223, and 224). At this time, when the setting information on the direct communication (extended data 78) is also acquired (steps 223 and 231), the direct communication based on the information is started (steps 227, 228, 229, and 230).

When the information about the wireless terminal 40 of the other side cannot be found in an ARP table in the step 223, an ARP request is sent (step 224), and an ARP response is awaited (step 225). When the ARP response is received, whether the extended data 78 is included is determined (step 226). When the data is included, the setting information for direct communication is set in the communication information storage unit 48e (step 227), and the direct communication of the step 228 or later is started.

When the extended data 78 is not included in an ARP response in the step 226, the communication via the wireless network 61a of the step 232 to the step 234 is performed. When the ARP response cannot be received in the step 225, processing terminates.

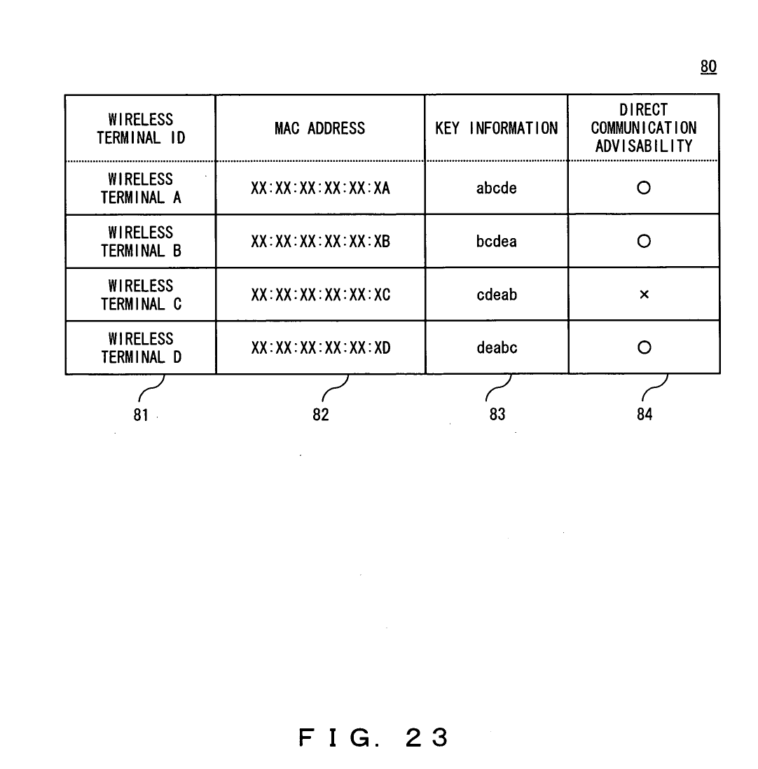

At this point, FIG. 23 shows an example of a setting information table 80 when the wireless terminal A holds setting information on direct communication. The setting information table 80 associates and stores a wireless terminal ID 81, an MAC address 82, key information 83, and a direct communication advisability flag 84 every individual wireless terminal ID 81.

When information on direct communication cannot be found in the setting information table 80, the communication through the normal wireless network 61a is performed (steps 232, 233, and 234).

When the wireless terminal A holds the information on direct communication with the wireless terminal B of the other side in its own setting information table 80 (step 231), the direct communication is started using the key information included in the direct communication information (step 228). When an ACK message is received from the wireless terminal B of the other side (step 229), the possibility of arrival of a message by direct communication is checked, and that the encrypted communication data was able to be decoded by the wireless terminal B of the other side is checked, then the direct communication is continued (step 230).

However, when an ACK message is not returned from the wireless terminal B of the other side (step 229), direct communication is determined to be impossible, and is switched the communication via the wireless network 61a (steps 232 to 234). When the communication via the wireless network 61a is also impossible (step 233), the wireless terminal B of the other side is determined to enter a non-communicable state, and the communication is terminated.

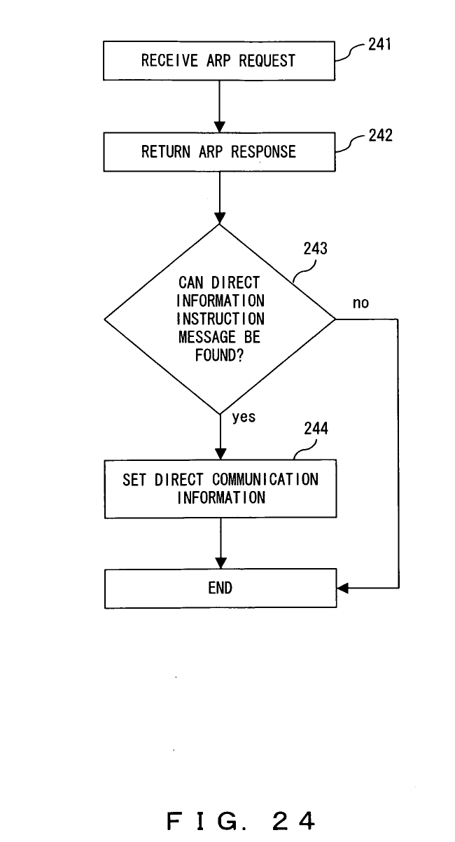

FIG. 24 is a flowchart showing the operation when setting information is sent from the communication apparatus 20A to the wireless terminal B of the receiving side, and when the wireless terminal B of the receiving side sets information on direct communication.

When the wireless terminal B receives an ARP request from the communication apparatus 20A (step 241), an ARP response is replied (step 242), and the receiving of the direct communication indication message (extended ARP message 70) from the communication apparatus 20A is awaited (step 243). When the receiving is successful, the setting information (extended data 78) for direct communication is set in the communication information storage unit 48e (step 244).

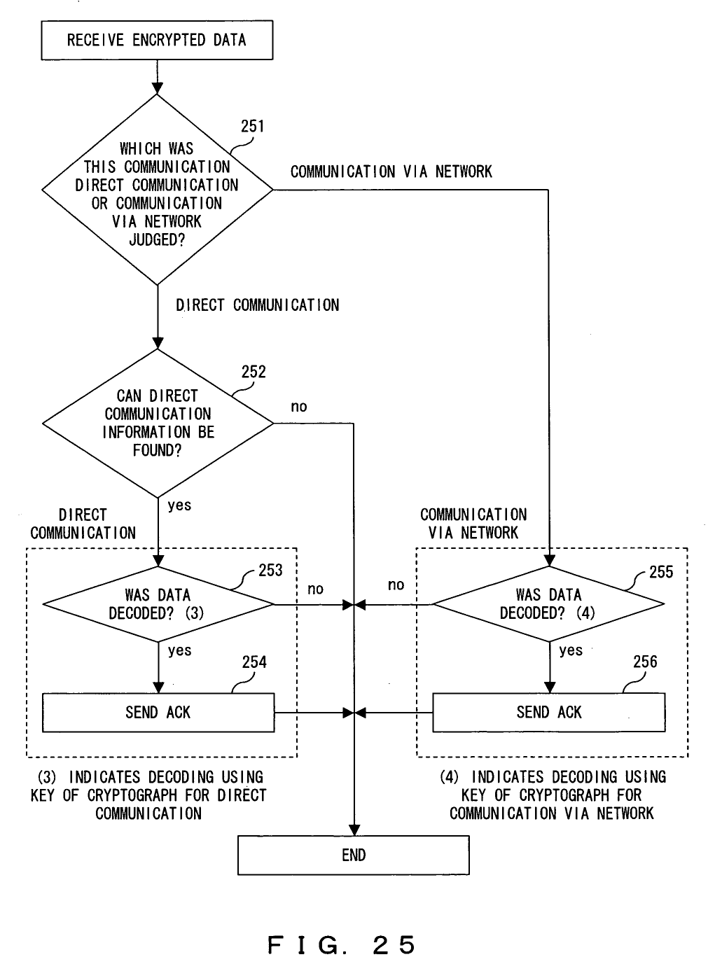

FIG. 25 is a flowchart showing the operation when the wireless terminal B determines whether the communication data to be received is the data via the wireless network 61a or the data of direct communication, and decodes the data encrypted using each key.

That is, the wireless terminal B determines direct communication or the communication via the wireless network 61a (step 251). In case of the direct communication, whether the information on the direct communication can be found in the communication information storage unit 48e is determined (step 252). When the information can be found, whether the decoding of data using the key for the direct communication is successful is determined (step 253). When the decoding was successful, an ACK message is sent (step 254).

When no direct communication is determined to be found in the step 251, data decoding is attempted using the key via the wireless network 61a (step 255), and an ACK message is sent when the decoding is successful (step 256).

At this time, when data cannot be decoded or when a key is not held in direct communication (step 253), the wireless terminal B of the receiving side does not operates especially, but stands ready for the wireless terminal A of the sending side that starts the communication via the wireless network 61a. On the contrary, when the data cannot be decoded, an ACK message is returned directly (step 254).

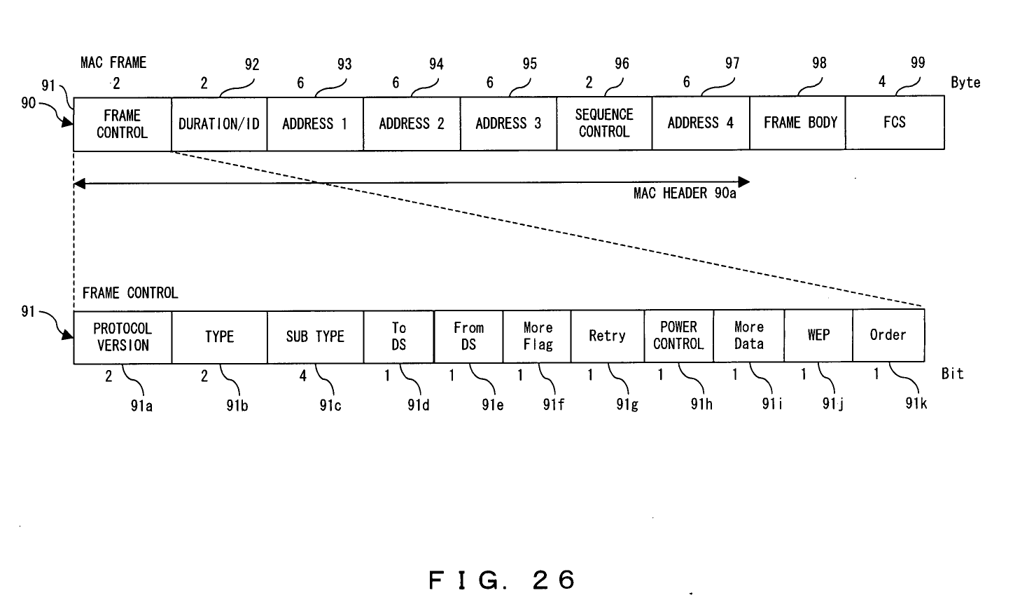

FIG. 26 is a conceptual illustration showing a configuration example of information on a MAC frame including a MAC header that is used when whether communication data is data via a network or direct communication data is determined.

A MAC frame 90 includes a MAC header 90a, a frame body 98, and a frame check sequence 99.

The MAC header 90a includes a frame control field 91 in which various types of control information are stored, a duration ID field 92 that indicates a scheduled period at which a wireless line is used, an address 1 field 93, an address 2 field 94, an address 3 field 95, a sequence control field 96 that indicates a sequence number of the MAC frame 90 and a fragment number for a fragment, and an address 4 field 97.

The frame body 98 stores send data. The frame check sequence 99 stores error detection codes of the MAC header 90a and the frame body 98.

Each address field of the address 1 field 93, the address 2 field 94, the address 3 field 95, and the address 4 field 97 varies in the number of fields used depending on the frame type of the MAC frame 90.

The frame control field 91 includes a protocol version 91a, a type field 91b, a sub type field 91c, a To DS field 91d, a From DS field 91e, a More Frag field 91f, a Retry field 91g, a power management field 91h, a More Data field 91i, a WEP field 91j, and an Order field 91k.

Two modes of an infrastructure mode and an ad hoc mode can be found in a wireless LAN. In case of the communication in the infrastructure mode via the normal communication apparatus 20A, the To DS field 91d or the From DS field 91c is set. In case of the communication in the ad hoc mode through which the normal communication apparatus 20A passes, the To DS field 91d and the From DS field 91e are set. In the ad hoc mode in which the wireless terminals 40 perform communication among themselves, both the To DS field 91d and the From DS field 91e are cleared.

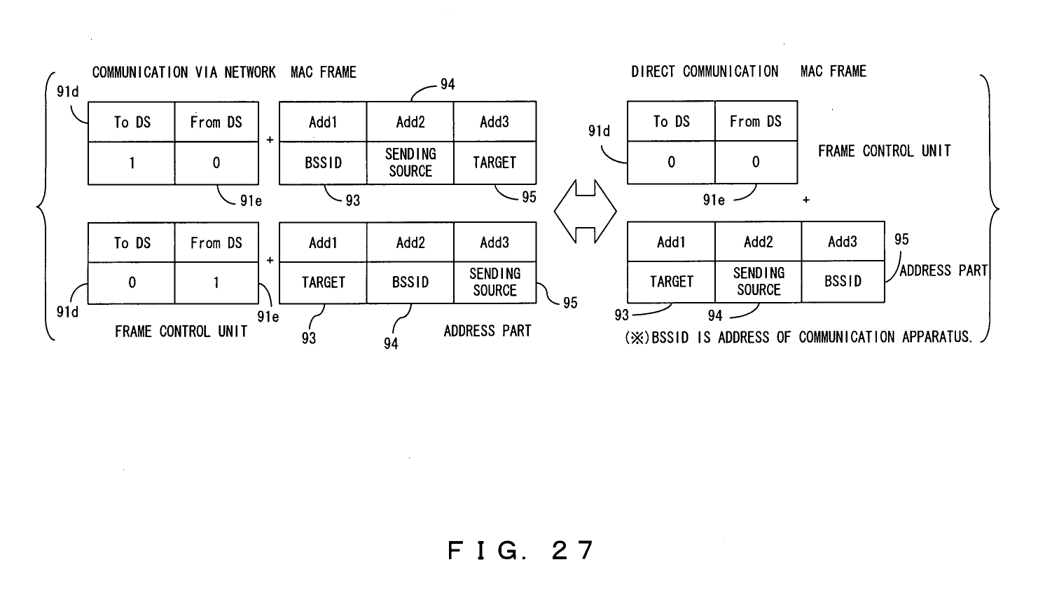

Accordingly, as illustrated at the left and right of FIG. 27, whether direct communication or communication via a network is used can be determined. In this case, the values of the To DS field 91d and the From DS field 91e, and the MAC addresses (address 1 field 93, address 2 field 94, or address 3 field 95) of the address part are checked.

That is, in the MAC frame 90 via the network (communication apparatus 20A) at the left of FIG. 27, when the To DS field 91d of the frame control field 91 is “1”, and the From DS field 91e is “0” (a receiving station is a base station), a BSSID is set in the address 1 field 93, and a sending source is set in the address 2 field 94, then a target address is set in the address 3 field 95.

When the To DS field 91d is “0”, and the From DS field 91e is “1” (a receiving station is abase station), a target address is set in the address 1 field 93, and a BSSID is set in the address 2 field 94, then a sending source address is set in the address 3 field 95.

On the other hand, in case of the direct communication illustrated at the right of FIG. 27, both the To DS field 91d and the From DS field 91e are “0” (no base station can be found). In this case, a target address is set in the address 1 field 93, and a sending source address is set in the address 2 field, then a BSSID is set in the address 3 field 95.

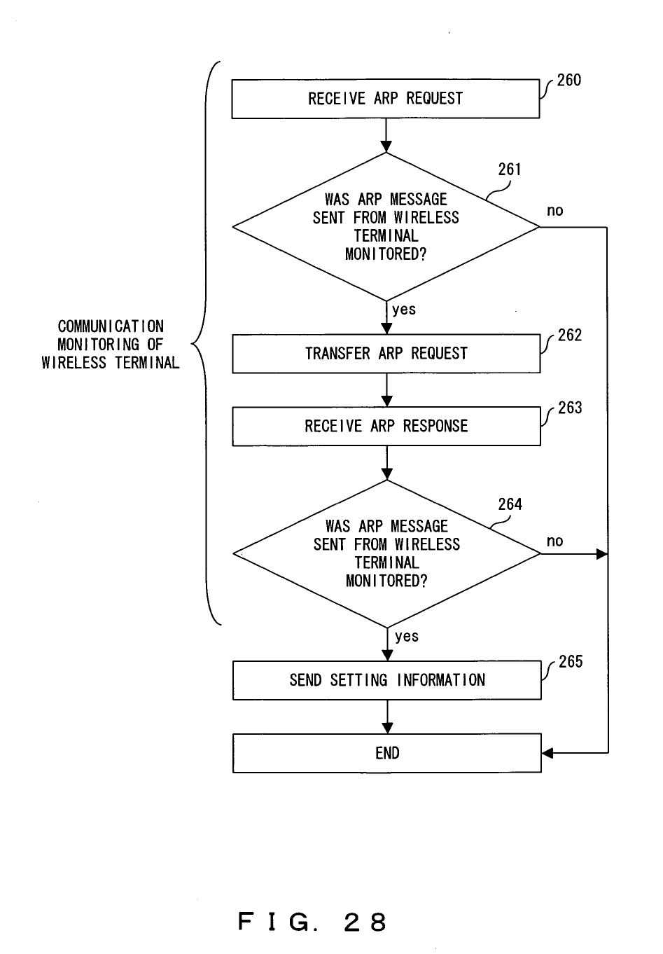

FIG. 28 is a flowchart showing the operation of the communication apparatus 20A in the communication sequences of FIGS. 18 and 19. The communication apparatus 20A monitors an ARP message sent from the wireless terminal 40 to be connected (steps 260 to 264), and detects the start of communication among the wireless terminals 40. When communication is detected (steps 260 and 261), the extended ARP message 70 that indicates an instruction of the direct communication in which an ARP message is extended to each wireless terminal 40 (steps 262 and 263). Because the communication path (wireless network 61a) between the communication apparatus 20A and the wireless terminal 40 is encrypted, the setting information (extended data 78) including key information cannot be tapped from the third party.

As described above, according to this embodiment 2, the communication apparatus 20A (e.g., access point in a wireless network system, e.g., a wireless LAN) monitors the communication among the wireless terminals 40. The communication apparatus, when detects the communication among the wireless terminals 40, distributes the setting information (extended data 78) for direct communication to the wireless terminal 40. The wireless terminal 40, on receiving this setting information, performs direct communication based on the setting information 53. This arrangement frees the user of the wireless terminal 40 from considering setting operation for direct communication every time on such occasions, and can realize the direct communication among the wireless terminals 40 with excellent convenience. At the same time, the total communication efficiency of a wireless network system can be increased through the direct communication among the wireless terminals 40.

The communication apparatus 20A can maintain the security having the same level as the communication via a network also in direct communication by distributing setting information including key information in the direct communication to the wireless terminal 40 that performs the direct communication.

According to the present invention, an ad hoc mode in which the communication among the wireless terminals themselves can be realized in direct communication with excellent convenience without forcing a user's troublesome operation.

According to the present invention, the ad hoc mode frees users from consciously selecting a suitable communication mode before starting communication.

According to the present invention, the ad hoc mode can realize the direct communication with excellent security.

The foregoing invention has been described in terms of preferred embodiments. However, those skilled, in the art will recognize that many variations of such embodiments exist. Such variations are intended to be within the scope of the present invention and the appended claims.

What is claimed is:

1. A wireless network system with a plurality of wireless terminals and at least one communication apparatus, the system being adapted for indirect communication where the wireless terminals communicate with each other via a network or direct communication where the wireless terminals directly communicate with each other, wherein the communication apparatus comprises
a function of preparing setting information necessary for the direct communication, and transmitting the setting information to the individual wireless terminals via the network, and
wherein the individual wireless terminal comprises
a function of, on receiving the setting information, starting the direct communication, based on the setting information.

2. The system according to claim 1, wherein the wireless terminal further comprises a function of encrypting communication data, based on key information included in the setting information, during the direct communication.

3. A communication method of a wireless network system with a plurality of wireless terminals and at least one communication apparatus, the system being adapted for indirect communication where the wireless terminals communicate with each other via a network or direct communication where the wireless terminals directly communicate with each other, the method comprising:
a step wherein the communication apparatus prepares setting information on the direct communication, and transmits the setting information to the individual wireless terminals via the network;
a step wherein the individual wireless terminals, on receiving and referring to the setting information, choose between the direct communication and the indirect communication depending on whether the direct communication is available or not.

4. The method according to claim 3, wherein the choosing step between the direct/indirect communication further comprises a function of encrypting communication data, based on key information included in the setting information, during the direct communication.

5. A communication apparatus served for the access from a plurality of wireless terminals via a network, comprising:
a storage unit that stores information about a wireless terminal in response to a registration request from the wireless terminal;
a monitoring unit that monitors communication of the wireless terminal registered in the storage unit, and detects indirect communication where the wireless terminals communicate with each other via a network;
a preparation unit that prepares setting information for direct communication where the wireless terminals directly communicate with each other as soon as the indirect communication is detected by the monitoring unit; and
a transmitting and receiving control unit that transmits the setting information to the wireless terminals in the indirect communication and to prompts the terminals to transfer to the direct communication.

6. The apparatus according to claim 5, wherein
the preparation unit determines whether the direct communication is available based on information about the wireless terminal registered in the storage unit, and if the direct communication is determined to be available, prepares setting information to transmit the setting information to the individual wireless terminals.

7. A wireless terminal for indirect communication where the wireless terminals communicate with each other via a network or direct communication where the wireless terminals directly communicate with each other, comprising:
a receiving unit that receives setting information on the direct communication, the setting information being transmitted from a communication apparatus via the network; and
a communication unit that performs the direct communication based on the received setting information.

8. The terminal according to claim 7, further comprising a function of encrypting communication data, based on key information included in the setting information, during the direct communication.

9. The terminal according to claim 7, further comprising:
a determination means that determines whether the direct communication is available based on the setting information received from a communication apparatus and
a function of switching to the indirect communication if the determination means determines that the direct communication is not available.

10. The terminal according to claim 9, wherein the determination means further comprises a confirmation function that checks the possibility of arrival of a message during the direct communication.

11. The terminal according to claim 9, wherein the determination means further comprises an authentication function that determines whether the wireless terminal of the other side is a valid communication party based on key information included in the setting information.

12. The terminal according to claim 7, wherein
a storage unit that stores the received setting information and address information of the wireless terminal of the other side terminal within a fixed time, and
a function of performing the direct communication based on the stored setting information in the storage unit, where communication is made with the other side terminal within the fixed time.

13. The terminal according to claim 7, further comprising
first/second communication media equipped with multiple communication media for performing the direct or indirect communication, and
a receiving unit that receives the setting information for the direct communication from the second communication media other than the fist communication media; and
a communication unit that performs the direct communication by first communication media, based on the received setting information.

14. A signal with a communication control program served for controlling a communication apparatus being accessed from a plurality of wireless terminals via a network, wherein the program allows the communication apparatus to realize:
a function of monitoring communication of the wireless terminal in connection and detecting the start of indirect communication where the wireless terminals communicate with each other via a network; and
a function of, on detecting the indirect communication, preparing setting information for direct communication where the wireless terminals directly communicate with each other, and transmitting the setting information to the wireless terminals.

15. The signal with the communication control program according to claim 14, wherein the program further allows the communication apparatus to realize:
a function of deciding whether to prepare the setting information on the direct communication based on address information of the wireless terminals registered in a communication apparatus.

16. A signal with a terminal control program served for controlling a wireless terminal, wherein the program allows the wireless terminal to realize:
a function of receiving setting information for direct communication where the wireless terminals directly communicate with each other from a communication apparatus, and performing the direct communication based on the received setting information.

17. The signal with the terminal control program according to claim 16, wherein the program further allows the wireless terminal to realize:
a function of, where key information is included in the setting information, encrypting communication data with use of the key information during the direct communication.

18. The signal with the terminal control program according to claim 16, wherein the program further allows the wireless terminal to realize:
a function of, where key information is included in the setting information, authenticating the wireless terminal of the other side using the key information, and
a function of, in failed authentication, determining the direct communication to be unavailable, and switching to the indirect communication where the wireless terminals communicate with each other via a network.

19. The signal with the terminal control program according to claim 16, wherein the program further allows the wireless terminal to realize:
a function of storing the setting information received from a communication apparatus for a fixed time, and, where the same wireless terminal is accessed within the fixed time, using the stored setting information to attempt the direct communication.

20. The signal with the terminal control program according to claim 16, wherein the program further allows the wireless terminal to realize:
a function of, where a plurality of communication media are available for the wireless terminal, receiving setting information from second communication media other than first communication media in the direct communication, and performing the direct communication based on the setting information.
